(19) United States
(12) Patent Application Publication
(10) Pub. No.: US 2007/0296931 A1
(43) Pub. Date: Dec. 27, 2007

(54) Focusing/zooming apparatus for optical projection device and projection optical system

(75) Inventors: Sang-jun Choi, Osan-si (KR); Jeong-ho Nho, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/783,451

(22) Filed: Apr. 10, 2007

(30) Foreign Application Priority Data
Jun. 23, 2006 (KR) 10-2006-0057039

(51) Int. Cl. G03B 21/14

(52) U.S. Cl. 353/101

(57) ABSTRACT

Provided are a focusing apparatus of an optical projection device having a simple structure and capable of a precisely in focusing and a projection optical system. The focusing apparatus includes: a frame including a female screw part having a first pitch; a body tube moveably installed in the frame and comprising a male screw part having a second pitch smaller than the first pitch; and an adjusting ring including a male screw part corresponding to the female screw part having the first pitch and a female screw part corresponding to the male screw part having the second pitch to support the body tube in the frame and move the body tube toward an optical axis direction.

### CROSS-REFERENCE TO RELATED APPLICATIONS

This application claims the benefit under 35 U.S.C. §119(a) of Korean Patent Application No. 2006-57039, filed on Jun. 23, 2006, in the Korean Intellectual Property Office, the entire disclosure of which is hereby incorporated by reference.

### BACKGROUND OF THE INVENTION

1. Field of the Invention

The present invention relates to an optical projection device, and more particularly, to a focusing apparatus for a digital light processing (DLP) optical projection device and a projection optical system.

2. Description of the Related Art

As well known, a digital light processing (DLP) optical projection device includes an illumination optical system, a digital micro-mirror device (DMD) module, and a projection optical system which magnifies and projects light including image information formed by the DMD module onto a screen.

The projection optical system includes a rear projection lens assembly which magnifies and focuses the light including the image information formed by the DMD module, a reflecting mirror which reflects the light having passed the rear projection lens assembly toward a predetermined direction, and a front projection lens assembly which magnifies and projects the light reflected by the reflecting mirror onto the screen.

The rear projection lens assembly includes a focusing apparatus, and FIG. 1 schematically illustrates a general rear projection lens assembly adopting such a focusing apparatus. Referring to FIG. 1, a rear projection lens assembly 10 includes a frame 11, a body tube 12 which is installed in the frame 11 so as to move in an optical axis direction, a fixed plate 13 which supports the body tube 12, and a focusing apparatus 14.

The focusing apparatus 14 includes an adjusting ring 17 and a push unit 18. The adjusting ring 17 includes a female screw part 16 and is rotatably assembled with the body tube 12. A male screw part 15 has a predetermined pitch formed on a portion of an outer surface of the body tube 12, and the female screw part 16 corresponds to the male screw part 15. The push unit 18 pushes the adjusting ring 17 toward the frame 11 which is a reference position of the projection optical system.

Lenses are installed at the body tube 12. Thus, the adjusting ring 17 may be rotated to move the body tube 12 toward the optical axis direction so as to focus a focal point of the projection optical system.

However, the projection optical system having the focusing apparatus 14 includes the adjusting ring 17, the fixed plate 13, and the push unit 18 including a magnet, a spring, etc. Thus, the projection optical system includes many parts. As a result, it is difficult to make the projection optical system compact, and assembling the projection optical system is complicated.

Also, the body tube 12 freely moves in the optical axis direction due to the rotation of the adjusting ring 17. Thus, a precision in focusing the focal point is lowered. In other words, after the focal point is focused, the push unit 18 such as the magnet or the coil spring pushes the adjusting ring 17 toward the frame 11 so that the adjusting ring 17 contacts the frame 11. However, the contact between the adjusting ring 17 and the frame 11 may not be achieved. Thus, the focal point may disperse.

### SUMMARY OF THE INVENTION

Accordingly, the present general inventive concept has been made to solve the above-mentioned and/or problems, and an aspect of the present general inventive concept is to provide a focusing apparatus of an optical projection device having a simple structure and capable of improving a precise in focusing.

Another aspect of the present general inventive concept is to provide a projection optical system of the optical projection device including the focusing apparatus.

According to an aspect of the present invention, there is provided a focusing apparatus for an optical projection device, including: a frame including a first screw part having a first pitch; a body tube moveably installed in the frame and including a second screw part having a second pitch; and an adjusting ring including a third screw part corresponding to the first screw part and a fourth screw part corresponding to the second screw part to support the body tube in the frame and move the body tube in an optical axis direction.

The first pitch may be different from the second pitch. The first pitch may be larger than the second pitch. A ratio of the first pitch to the second pitch may be 2:1.

The first and fourth screw parts may be female screw parts, and the second and third screw parts may be male screw parts.

According to another aspect of the present invention, there is provided a focusing apparatus for an optical projection device, including: a frame providing a reference surface of an optical system; a body tube installed in the frame and including a plurality of lenses; and an adjusting ring supporting the body tube in the frame and rotating to advance and retreat the body tube in the optical axis direction.

The adjusting ring may include a first tube part including a male screw part having a first pitch and a second tube part including a female screw part having a second pitch, wherein the male screw part is screwed to the frame, and the female screw part is screwed to the body tube.

A diameter of the second tube part may be larger than a diameter of the first tube part, and an uneven part may be formed on an outer surface of the second tube part to prevent the second tube part 320 from slipping out of the user's hand. The first pitch may be larger than the second pitch.

According to another aspect of the present invention, there is provided a projection optical system of an optical projection device including: a rear projection lens assembly magnifying and focusing light including image information formed by a digital micro-mirror device (DMD) module; and a front projection lens assembly projecting the light irradiated from the rear projection lens assembly onto a screen. The rear projection lens assembly may include: a frame including a female screw part having a first pitch; a body tube moveably installed in the frame and including a male screw part having a second pitch; and an adjusting ring including a male screw part corresponding to the female screw part having the first pitch and a female screw part corresponding to the male screw part having the second pitch to support the body tube in the frame and move the body tube in an optical axis direction.

The projection optical system may further include a body tube rotation preventing unit preventing the body tube from rotating during its movement in the optical axis direction.

The body tube rotation preventing unit may include: a slit formed in the frame to be lengthened toward a direction parallel with the optical axis direction; and a screw screwed to the body tube through the slit.

The projection optical system may further include a reflecting mirror reflecting the light comprising the image information irradiated from the rear projection lens assembly toward the front projection lens assembly.

The screw may be screwed to the body tube through a guide member having a diameter equal to a width of the slit in a short axis direction.

An end part of the body tube may be D-cut.

### BRIEF DESCRIPTION OF THE DRAWINGS

The above aspects and features of the present invention will be more apparent by describing certain embodiments of the present invention with reference to the accompanying drawings, in which:

FIG. 1 is a view schematically illustrating a focusing apparatus of a general optical projection device;

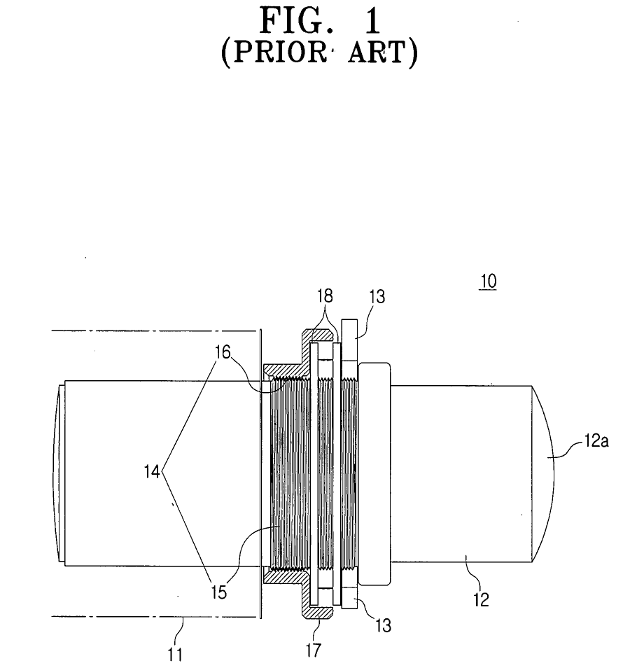

FIG. 2 is an exploded view illustrating a focusing apparatus according to an embodiment of the present invention;

FIG. 3 is an assembly diagram illustrating the focusing apparatus illustrated in FIG. 2;

FIG. 4 is a bottom view illustrating the focusing apparatus illustrated in FIG. 2; and

FIG. 5 is a view schematically illustrating a projection optical system of an optical projection device adopting a focusing apparatus according to an embodiment of the present invention.

### DETAILED DESCRIPTION OF THE PREFERRED EMBODIMENTS

The first pitch P1 of the adjusting ring male screw part 311 may be different from the second pitch P2 of the adjusting ring female screw part 321. According to an aspect of the present invention, the first pitch P1 may be 1 mm, and the second pitch P2 may be 0.5 mm.

The first and second pitches P1 and P2 may vary depending on sizes of lenses of the projection optical system, and a ratio between the first and second pitches P1 and P2 may be changed into a different ratio. The second pitch P2 may be larger than the first pitch P1.

A BFL position shift of the body tube 200 satisfies Equation 1:

BFL Position Shift=(First Pitch (P1)−Second Pitch (P2))×Rotation Angle/360 (1)

For example, if the adjusting ring 300 rotates once (through 360°), the first pitch P1 is 1 mm, and the second pitch P2 is 0.5 mm. Thus, the BFL shift of the body tube 200 is +0.5 mm.

According to an aspect of the present invention, if the adjusting ring 300 is rotated to adjust a BFL of the body tube 200, a body tube rotation preventing unit 400 may be further included to prevent the body tube 200 from rotating due to the rotation of the adjusting ring 300.

The body tube rotation preventing unit 400 includes a slit 410 formed in the frame 100 and a screw 430.

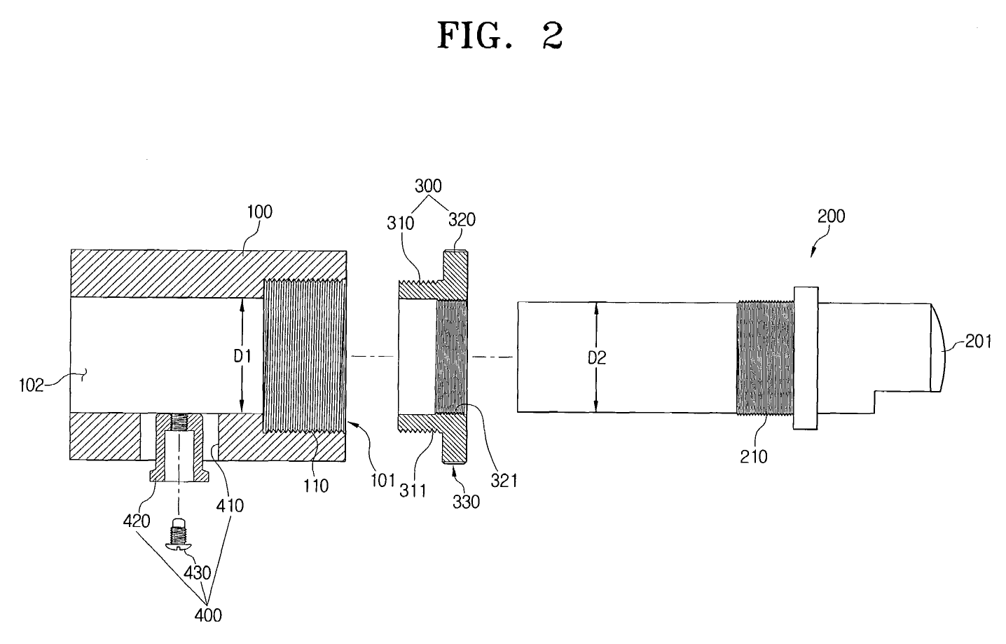

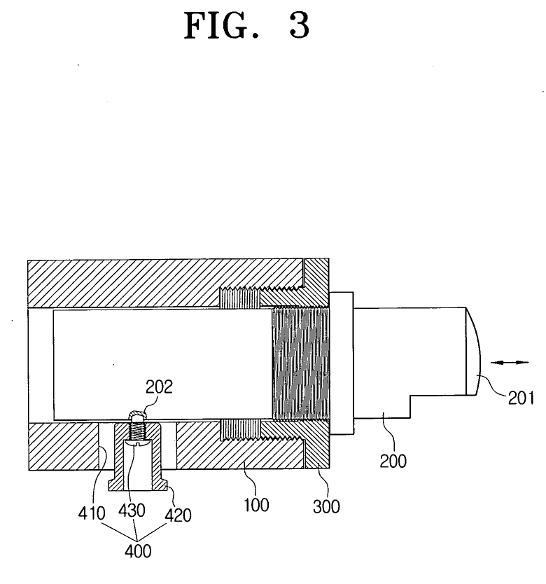

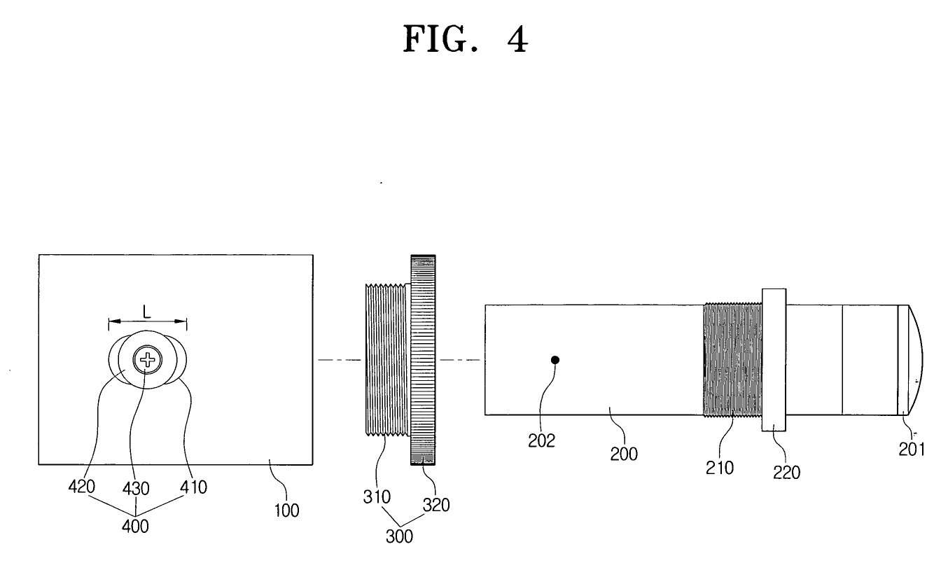

The slit 410 penetrates the frame 100 in a direction parallel with the optical axis as shown in FIGS. 2 through 4 so as to be connected to the body tube installing part 102 formed in the frame 100. Also, the screw 430 is screwed to a screw hole 202 formed in the body tube 200 through the slit 410. Thus, the body tube 200 may be moved by the screw 430 in the optical axis direction but may be restrained from rotating based on the optical axis.

The body tube 200 is installed in the frame 100 to be moved by the adjusting ring 300. The body tube 200 performs a sliding operation with a rotation of the adjusting ring 300 to advance and retreat based on an optical axis. Black focal lengths (BFLs) of a plurality of lenses installed in the body tube 200 are adjusted by the sliding operation. For this purpose, a body tube male screw part 210 having a second pitch P2 is formed on a portion of the surface of the body tube 200 and screwed to the adjusting ring 300.

A flange 220 is formed on the body tube 200 in a position adjacent to the body tube male screw 210 to prevent the body tube 200 from being excessively inserted into the frame 100 during adjusting of the BFLs of the body tube 200 using the rotation of the adjusting ring 300.

Portions of parts, which are adjacent to and interfere with the body tube 200, may be eliminated to make a digital light processing (DLP) engine compact. For example, a front lens 201, which may interfere with an illumination lens (not shown) forming an illumination optical system, may be D-cut as shown in FIG. 2. If the front lens 210 is D-cut as described above, spaces wasted by interference with other parts adjacent to the front lens 201 may be minimized. However, although a lens is D-cut as described above, light including image information does not pass a D-cut portion of the lens. Thus, D-cutting does not affect the projection of an image.

The adjusting ring 300 includes a first tube part 310 and a second tube part 320 having a larger diameter than the first tube part 310.

The first tube part 310 includes an adjusting ring male screw part 311 corresponding to the frame female screw part 110 having the first pitch P1, and the second tube part 320 includes an adjusting ring female screw part 321 corresponding to the body tube male screw part 210 having the second pitch P2. An uneven part 330 is formed on the surface of the second tube part 320 to prevent the second tube part 320 from slipping out of the user's hand.

Certain embodiments of the present invention will be described in greater detail with reference to the accompanying drawings.

In the following description, same drawing reference numerals are used for the same elements in different drawings. The matters defined in the description such as a detailed construction and elements are provided to assist in a comprehensive understanding of the invention. It is apparent that the present invention can be carried out without those detailed defined matters. Also, well-known functions or constructions are not described in detail since they would obscure the invention in unnecessary detail.

Referring to FIGS. 2 through 4, a focusing apparatus of an optical projection device according to an embodiment of the present invention includes a frame 100, a body tube 200, and an adjusting ring 300.

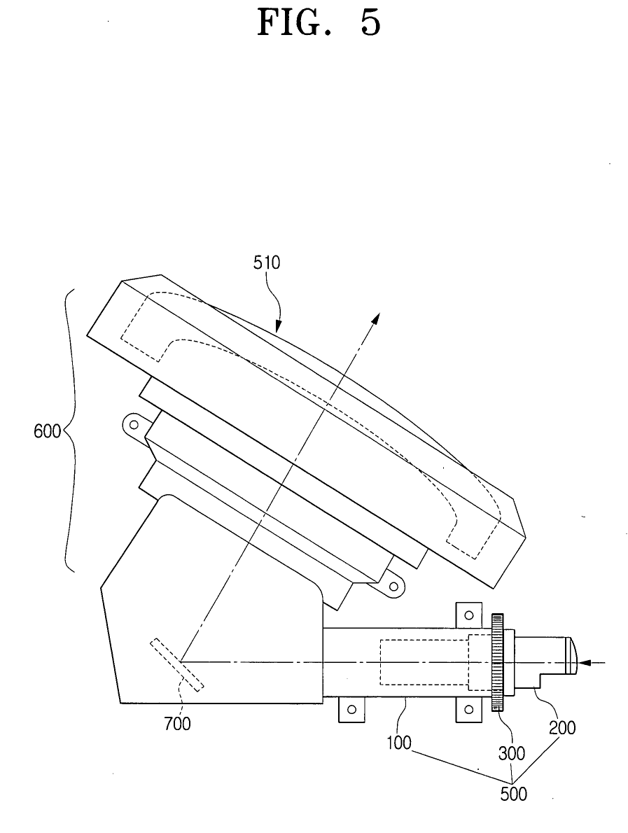

A body tube installing part 102 is provided in the frame 100 and connected to a front projection lens assembly 600 and a reflecting mirror 700, which will be described later with reference to FIG. 5, so as to form a predetermined optical path.

A diameter D1 of the body tube installing part 102 is equal to a diameter D2 of the body tube 102, and the body tube installing part 102 has a very small tolerance to prevent an optical axis from swaying. Also, a frame female screw part 110 having a first pitch P1 is formed on an inner surface of an entrance 101 of the body tube installing part 102 so that the adjusting ring 300 is screwed to the frame male screw 110.

The body tube 200 receives light including image information from an illumination optical system (not shown), magnifies and focuses the light at a predetermined magnification, and transmits the light to a projection lens 610 installed at the front projection lens assembly 600 shown in FIG. 5.

The screw 430 may be screwed to the body tube 200 through a guide member 420 as shown in FIGS. 2 through 4 to smoothly move the body tube 200 toward the optical axis direction. For this purpose, a diameter of the guide member 420 may be equal to a width of the slit 410. If the guide member 420 is used as described above, the screw 430 may be prevented from being worn due to a contact with the slit 410 during moving of the body tube 200.

A projection optical system having a focusing apparatus of an optical projection device according to an embodiment of the present invention will now be described.

The projection optical system according to the present embodiment includes a rear projection lens assembly 500 and a front projection lens assembly 600. The rear projection lens assembly 500 receives light from an illumination optical lens assembly (not shown) and an image from a digital micro-mirror device (DMD) module (not shown) and magnifies and focuses the light and the image. The image magnified and focused by the rear projection lens assembly 500 is transmitted to the front projection lens assembly 600 through a reflecting mirror 700 and then projected onto a screen (not shown).

The rear projection lens assembly 500 includes the frame 100, the body tube 200, and the adjusting ring 300. The frame 100 includes the frame female screw part 110 having the first pitch P1. The body tube 200 is moveably installed in the frame 100 and includes the body tube male screw part 210 having the second pitch P2. The adjusting ring 300 includes the adjusting ring male screw part 311 corresponding to the frame female screw part 110 having the first pitch P1 and the adjusting ring female screw part 321 corresponding to the body tube male screw part 210 having the second pitch P2.

The adjusting ring 300 supports the body tube 200 in the frame 100 and moves the body tube 200 toward the optical axis direction so as to adjust the BFLs of the lenses installed in the body tube 200.

The front projection lens assembly 600 includes the projection lens 610 which projects the image magnified and focused by the rear projection lens assembly 560 onto the screen.

If the projection optical system has the above-described structure, the adjusting ring 300 adjusts the BFL of the body tube 20 and simultaneously fixes the body tube 200 to the frame 100. Thus, a number of parts of the projection optical systems can be reduced.

When the adjusting ring 300 is rotated to adjust the BFL of the body tube 200, the body tube 200 may not rotate with the adjusting ring 300 and may move back and forth toward a direction parallel with an optical axis. Thus, the BFL of the body tube 200 may be stably and precisely adjusted even in the projection optical system in which the body tube 200 cannot rotate as when a lens installed in the body tube 200 is D-cut.

Also, the second pitch P2 is denser than the first pitch P1. Thus, a shift distance of the body tube 200 may be further precisely adjusted. In other words, if the first pitch P1 is 1 m and the second pitch P2 is 0.5 mm as in the previous embodiment, the body tube 200 may move by about 0.0027 mm toward the optical axis direction when the adjusting ring 300 rotates through 1°. Thus, the BFL can be very precisely adjusted.

As described above, according to the present invention, a body tune can be supported in a frame using a member, i.e., an adjusting ring, and simultaneously a BFL of the body tube can be adjusted. Thus, a focusing apparatus for focusing the BFL of the body tube can be constituted using a small number of parts. As a result, the focusing apparatus can be simply assembled, and its manufacturing cost can be reduced.

Also, the adjusting ring can have different pitches to minutely move the body tube with the rotation of the adjusting ring. As a result, the BFL can be further precisely adjusted.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A focusing apparatus for an optical projection device, comprising:
a frame comprising a first screw part having a first pitch;
a body tube moveably installed in the frame and comprising a second screw part having a second pitch; and
an adjusting ring comprising a third screw part corresponding to the first screw part and a fourth screw part corresponding to the second screw part to support the body tube in the frame and move the body tube in an optical axis direction.

2. The focusing apparatus of claim 1, wherein the first pitch is different from the second pitch.

3. The focusing apparatus of claim 2, wherein the first pitch is larger than the second pitch.

4. The focusing apparatus of claim 3, wherein a ratio of the first pitch to the second pitch is 2:1.

5. The focusing apparatus of claim 1, wherein the first and fourth screw parts are female screw parts, and the second and third screw parts are male screw parts.

6. A focusing apparatus for an optical projection device, comprising:
a frame providing a reference surface of an optical system;
a body tube installed in the frame and comprising a plurality of lenses; and
an adjusting ring supporting the body tube in the frame and rotating to advance and retreat the body tube in the optical axis direction.

7. The focusing apparatus of claim 6, wherein the adjusting ring comprises a first tube part comprising a male screw part having a first pitch and a second tube part comprising a female screw part having a second pitch, wherein the male screw part is screwed to the frame, and the female screw part is screwed to the body tube.

8. The focusing apparatus of claim 7, wherein a diameter of the second tube part is larger than a diameter of the first tube part, and an uneven part is formed on an outer surface of the second tube part to prevent the second tube part from slipping out of the user's hand.

9. The focusing apparatus of claim 7, wherein the first pitch is larger than the second pitch.

10. A projection optical system of an optical projection device comprising:
a rear projection lens assembly magnifying and focusing light comprising image information formed by a digital micro-mirror device (DMD) module; and
a front projection lens assembly projecting the light irradiated from the rear projection lens assembly onto a screen,
wherein the rear projection lens assembly comprises:
a frame comprising a female screw part having a first pitch;
a body tube moveably installed in the frame and comprising a male screw part having a second pitch; and
an adjusting ring comprising a male screw part corresponding to the female screw part having the first pitch and a female screw part corresponding to the male screw part having the second pitch to support the body tube in the frame and move the body tube in an optical axis direction.

11. The projection optical system of claim 10, wherein the first pitch is different from the second pitch.

12. The projection optical system of claim 11, wherein the first pitch is larger than the second pitch.

13. The projection optical system of claim 12, wherein a ratio of the first pitch to the second pitch is 2:1.

14. The projection optical system of claim 13, further comprising a body tube rotation preventing unit preventing the body tube from rotating during its movement in the optical axis direction.

15. The projection optical system of claim 14, wherein the body tube rotation preventing unit comprises:
a slit formed in the frame to be lengthened toward a direction parallel with the optical axis direction; and
a screw screwed to the body tube through the slit.

16. The projection optical system of claim 10, further comprising a reflecting mirror reflecting the light comprising the image information irradiated from the rear projection lens assembly toward the front projection lens assembly.

17. The projection optical system of claim 15, wherein the screw is screwed to the body tube through a guide member having a diameter equal to a width of the slit in a short axis direction.

18. The projection optical system of claim 14, wherein an end part of the body tube is D-cut.
